(19) United States
(12) Patent Application Publication
(10) Pub. No.: US 2008/0156418 A1
(43) Pub. Date: Jul. 3, 2008

(54) Method for Producing an Elastic Web Material

(76) Inventor: Sandra Fenske, Einhausen (DE)

Correspondence Address: NORRIS, MCLAUGHLIN & MARCUS, P.A., 875 THIRD AVE, 18TH FLOOR, NEW YORK, NY, 10022, US

(21) Appl. No.: 11/569,454

(22) PCT Filed: May 21, 2005
(86) PCT No.: PCT/EP05/05527

§ 371 Date: Jun. 6, 2007

(30) Foreign Application Priority Data
May 25, 2004 (DE) 10 2004 026 070.2

(51) Int. Cl. B32B 37/12

(52) U.S. Cl. 156/161

(57) ABSTRACT

The invention relates to a method for continuously producing a flexible elastic web material having two outer material webs or layers (20, 32), of which at least one is made of a textile material, and between which a pretensioned elastic intermediate ply is inserted that, when relieved from tension, causes the web material to shorten, and when tension is exerted thereupon, enables the web material to be elastically lengthened again. In order to produce the web material, the first material web or layer (20) is shaped to form a tube, and a contract adhesive (24) is applied thereto. Afterwards, a pattern (26, 28) of elastic threads or stands are, while pretensioned, progressively placed onto the outer side of this tube in a continuous manner in the longitudinal direction of the tube. A second material web or layer (13) is then placed onto the first tubular material web or layer provided with the pretensioned elastic threads, and is progressively joined in an adhering manner to the first material web or layer. The tube obtained hereby that is comprised of two material webs or layers with the embedded pattern consisting of pretensioned elastic threads or strands is then cut up in the longitudinal direction and unfolded in order to obtain the desired surface-elastic web material.

The invention relates to a method for continuous production of a flexible elastic web material with two outer material layers, of which at least one is made from a textile material, between which layers a prestressed, elastic intermediate layer is inserted, th which the web material is shortened by a release of tension in the intermediate layer, and can again be extended elastically by exertion of tensile stress.

Textile materials that can be extended elastically from an initially unstressed state in at least one coordinate direction are used, in particular, in connection with undergarments and corsetry that, based on the elasticity of the material, provide an effective, firm, large-area fit of pieces of clothing on or into which the material is processed, in order to avoid the disadvantages of band-shaped pressure spots on the body of the wearer created from specially sewn on or drawn-in elastic tape for a sufficiently firm fit, eg, in the waist or the leg openings of underpants. Through the use of such area-elastic material, a processing is possible, by which a large contact area of the piece of clothing on the body is obtained with a relatively low surface pressure, with a good fit at the same time. Textile materials produced from or with co-application of elastomer fibres in the form of a knitted fabric enable the production of elastic underwear, eg, support pants and hosiery. However, these materials are costly to produce and therefore, are not suitable for incorporation in inexpensive undergarments that are intended for single use, eg, for incontinence undergarments or also baby nappies. However, for just such applications, an inexpensive material is necessary that guarantees a sealed opening, particularly, in the leg area, with a secure hold against unintended removal of the undergarment, in order to ensure that no excreted bodily fluids can leak out from the absorbent interlining usually provided.

The invention is therefore based on the task of creating a production method that enables continuous production of a surface-elastic textile web material with a high-volume production capacity and, consequently, at a low price.

Starting from a method of the type mentioned in the introduction, this task is solved according to the invention, in that initially the front end of the first outer layer of the textile material is applied onto the end section of a longitudinally extended rod-like or pipe-like mould core, and simultaneously with the initiation of a feed motion on the mould core, it is folded around the mould core in a tubular closed form; that during the feed motion on the mould core, a pressure-sensitive adhesive is applied on the free top surface; that in the course of the further feed motion on the mould core, the tubular first layer of textile material is guided successively through two feed mechanisms, distanced from each other in the direction of motion, in each case, for a group of prestressed elastic threads or strands, where the elastic threads or strands are guided in each feed mechanism on a ring-shaped support surrounding the longitudinally extended mould core in the circumferential direction in individual guides arranged offset from each other, and applied under prestressing onto the first outer layer, and are bound to it by the pressure-sensitive adhesive; that during the feed motion of the tubular first layer on the mould core, the ring-shaped supports of the individual guides are driven rotationally in opposite directions from each other about the longitudinal axis of the mould core, so that the threads or strands of both groups are applied onto the tubular first layer on the basis of the overlaid feed motion of the first layer and the rotation of the carriers in two groups, running obliquely counter to each other, of elastic treads or strands oriented essentially parallel to each other, and surrounding the tubular first layer, in each case in the form of a tubular reinforcement; and that the second material layer is then applied onto the first tubular material layer overlaid with the applied groups of elastic threads or strands, and during the further feed motion is folded tubularly around the mould core, and is bonded through adhesion to the first material layer and the applied elastic prestressed threads or strands, whereupon the tube-like web material created in this way is sliced open in the longitudinal direction and unfolded into an essentially plane-surface web material.

This proceeds advantageously in such a way that the pressure-sensitive adhesive is applied onto the elastic threads or strands alone before, during, and/or after the application of the elastic threads or strands to the free top surface of the first material layer, or to the elastic threads or strands and the first material layer onto the mould core during its feed motion. A textile material is used for the first material layer.

For the second material layer, likewise, a textile material, or a film, can be used.

In the case of a film, it is recommended that a film permeable to gas or water vapour, but impermeable to fluids, be used as the film material.

We can also proceed in such a way that a layer of a plastic is applied in a free-flowing state, eg, brushed or sprayed, which subsequently transforms into a flexible film or mat-like state, as a second material layer, onto the first material layer, which has been overlaid with the applied groups of elastic threads or strands.

It is then advantageous to use as a plastic a thermoplastic plastic transformed into a free-flowing state through heating, which, after the application onto the first material overlaid with the applied groups of elastic threads or strands, is transformed into the film-like or mat-like state through cooling. Alternatively, a plastic material capable of hardening through evaporation or vaporisation of a solvent, or a plastic material of a mixture of at least two fluid components, capable of hardening through cross-linking can be also be used as a plastic.

In an advantageous further development for implementing the method of the invention, a mould core provided with at least two slit-shaped or trough-shaped grooves, offset from each other in the circumferential direction, can be used, whereby during application of the first material layer onto the mould core over the slit-shaped or trough-shaped grooves, strip-like areas of the material layer are then moulded into the grooves and are held in the grooves during the feed motion. During application of the groups of elastic threads or strands, the material areas then formed into the grooves are not overlaid with such elastic threads or strands and are bound together with them; ie, parallel strip-like material areas running in the direction of production form in the web material that is sliced open later, which are alternately overlaid with elastic threads or strands, or are free from such elastic threads or strands. Thus, the web material created this way has elasticity only in the strip-like areas overlaid with the elastic threads or strands, while the strip-like areas lying in between have no elastic properties—or only the elasticity of the current base material.

In a further development of the invention, before or during the application of the second layer onto the first layer supplied with the groups of elastic threads or strands, additionally, a powder, flake, or fibre filler material or functional material can be applied, which has, for example, hygroscopic, ie fluid-absorbing and retaining properties. Also, through the cushioning properties of the filler or functional material, an increase in the wearing comfort of the material can be achieved in this way.

The invention will be described in more detail in connection with the drawings, which schematically illustrate the implementation of the method according to the invention for the production of an elastic area web material:

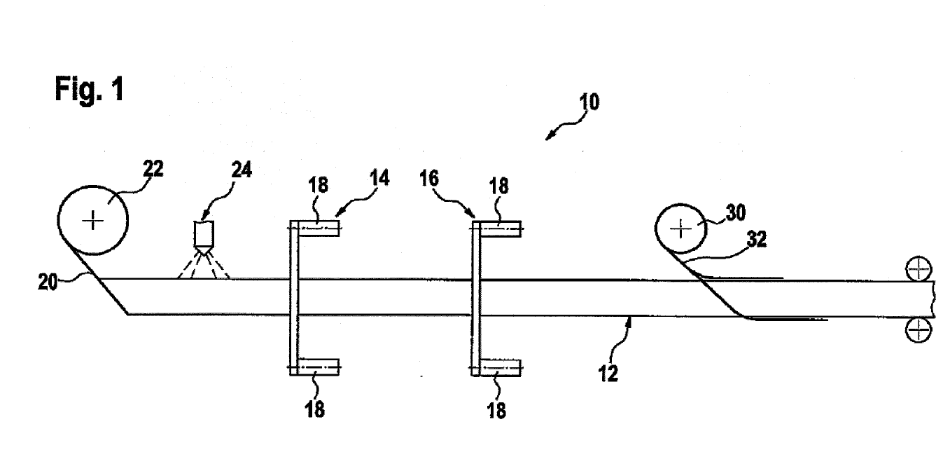

FIG. 1 shows a side view of the essential functional elements of a device usable in an implementation of the method according to the invention, in a highly schematic representation;

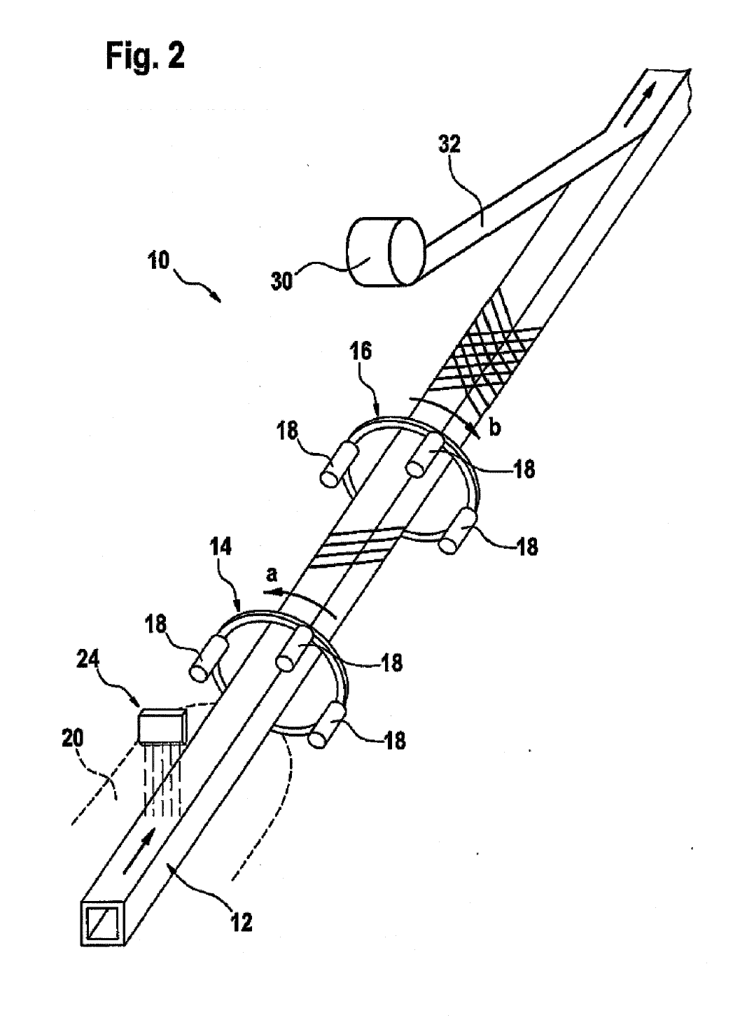

FIG. 2 shows a perspective view of the device shown in FIG. 1;

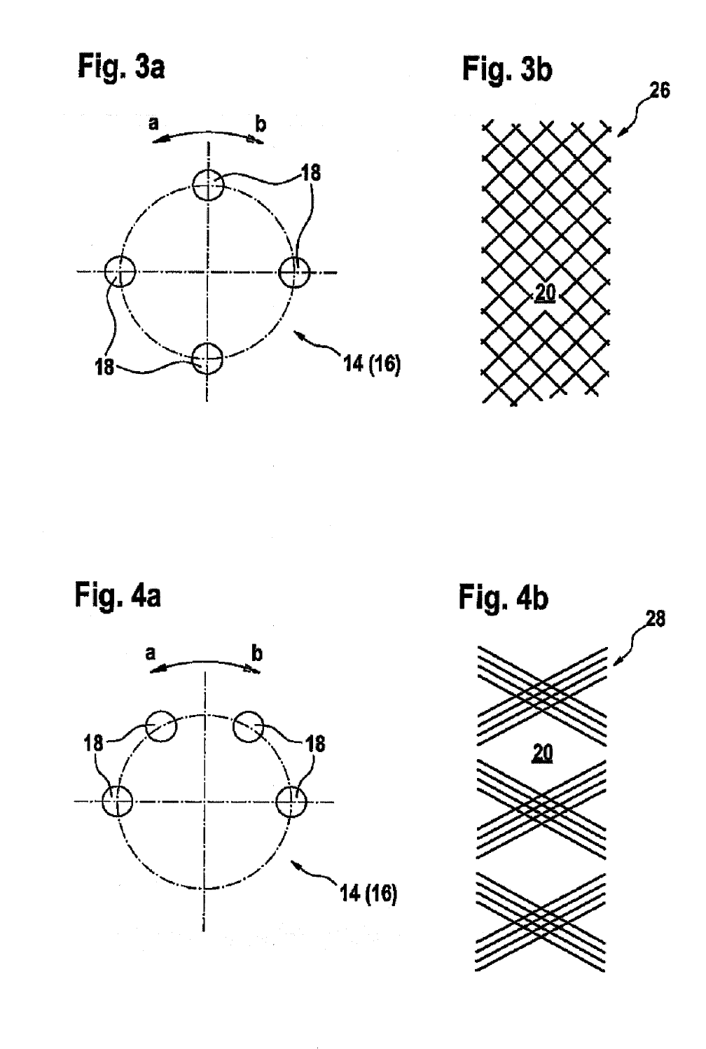

FIG. 3a shows the arrangement of the individual guides in a feed mechanism in the device according to FIGS. 1 and 2 for the application of groups of prestressed elastic threads or strands;

FIG. 3b shows the surface pattern of the elastic threads or strands obtained by using two feed mechanisms driven in opposite directions from each other, according to FIG. 3a, on a web material produced in the manner according to the invention;

FIG. 4a shows a different schematic arrangement of the individual guides in a feed mechanism provided in the apparatus according to FIGS. 1 and 2 for the application of groups of prestressed elastic threads or strands;

FIG. 4b shows the surface pattern of the elastic threads or strands obtained by using two feed mechanisms driven in opposite directions from each other, according to FIG. 3a, on a web material produced in the manner according to the invention;

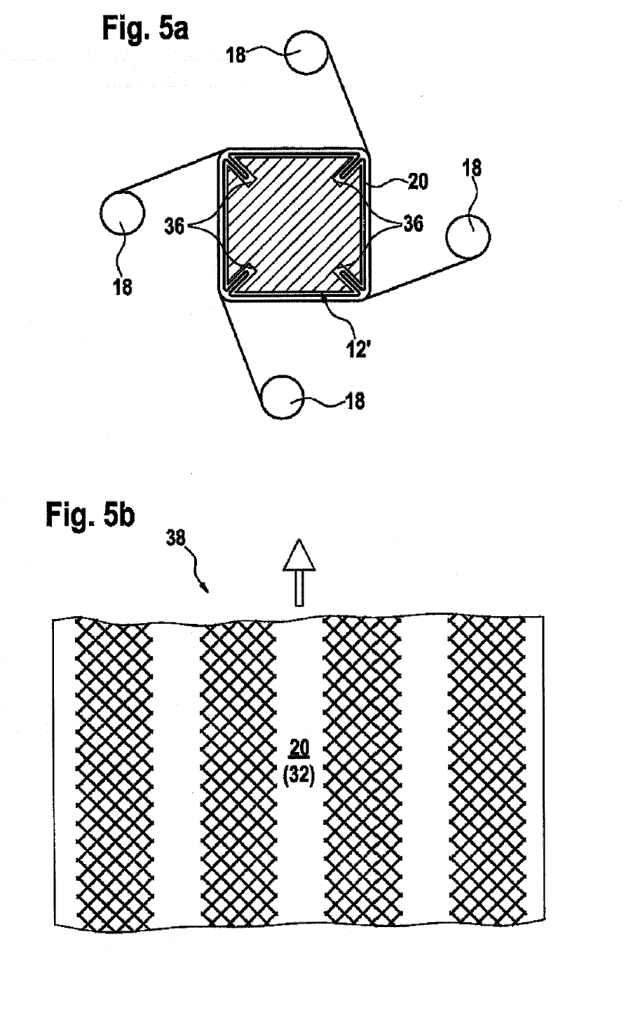

FIG. 5a shows a sectional view orthogonal to the longitudinal extent of a mould core through a modified mould core in the area of a feed mechanism for the elastic threads or strands; and

FIG. 5b shows the representation of the surface pattern of the elastic threads or strands created during the production of the web material using the mould core shown in FIG. 5a.

The device 10, represented highly schematically and simplified in FIGS. 1 and 2 for implementing the method according to the invention, has a mould core 12, longitudinally elongated and, in the case shown, square in cross section, which is concentrically surrounded by two feed mechanisms 14 and 16, offset from each other in the longitudinal direction. The feed mechanisms 14 and 16 can be driven rotationally in opposite directions of rotation, shown by arrows a and b, where the exact physical form and orientation of the feed mechanisms, and their driving devices, surrounding the mould core, are not shown reasons of clarity.

In the feed mechanisms 14 and 16, individual guides 18 for the elastic threads or strands are arranged in each case in the circumferential direction on a distributed ring-shaped support, offset from each other, by means of which, in each case, such an elastic thread or string can be guided under prestressing or pre-elongation in the direction to the mould core 12.

From the end of the mould core 12, located in the left in FIG. 1 and at the bottom in FIG. 2, a plane-surface textile-material web 20 is supplied rolled up to a roller 22, whereby the roller 22 is mounted so as to pivot on a mounting axis, so that the material 20 is unrolled from the roller and applied onto the mould core 12, and can then be sprayed from a discharge device 24 with a free-flowing pressure-sensitive adhesive. The first mat-like material web is then folded around the mould core in a tubular closed form and guided along the mould core 12 in this tubular closed or partially closed form continually—in FIG. 1 toward the right and in FIG. 2 diagonally upward—whereby the mat-like material, now tubular and sprayed with the still unset or not hardened pressure-sensitive adhesive consecutively passes through the feed mechanisms 14 and 16.

In the feed mechanisms in each case, a prestressed elastic thread or strand is applied onto the material web 20, in each case, by the individual guides 18 rotating with the feed mechanism, and fixed there by the pressure-sensitive adhesive 24—after its curing. Through the overlaying of the rotational motion of the individual guides 18 in the feed mechanisms 14, 16, driven in directions opposite to one another, and the feed motion of the tubular closed material web, the prestressed threads or strands are fixed on the first mat-like material in a surface pattern formed from two groups of threads or strands aligned in each group essential parallel to one another, running diagonally in opposite directions. This surface pattern, shown in FIG. 3b, is, for example, created with the arrangement, shown schematically in FIG. 3a, of four individual guides 18 with a uniform angular offset of 90° to the feed mechanism in each case. It is recognisable that the surface pattern 26 shown there is formed from threads running diagonally in opposite directions that intersect one another.

If the individual guides 18 are now arranged in the shown manner in FIG. 4a over only a part of the entire circumference of the feed mechanism 14 and 16, a surface pattern 28 of the prestressed elastic threads or strands forms on the material 20, as shown in FIG. 4b.

After the tubular material web 20 passes through the second feed mechanism 16, another layer of a textile material 32, here too assumed as a mat, is unrolled from a second supply roll 30, is applied onto the outer side of the first material web 20 overlaid with the elastic thread or strands, facing away from the mould core, and is likewise folded around in a tubular closed form and fixed to the first material web 20 by the pressure-sensitive adhesive, which has not yet hardened. In total, a two layer tube thereby arises, between which the elastic threads or strands are enclosed in the surface pattern created in the manner of a tubular reinforcement.

As soon as the pressure-sensitive adhesive is then fixed and the two outer layers are bound adhesively with the elastic threads lying in between, the tube formed in this way is slit open during another production feed motion, and then unfolded into a plane-surface web material, which can then again be rolled onto a roller as the final product.

After the tube is cut open, the plane-surface web material created in this way is then pulled together elastically, and thus its surface is reduced by the prestressing of the elastic threads or strands of the reinforcement, whereby an area elastic web material arises; ie, when the tension is increased, it can again be extended elastically, from which material the pre-cut parts can be produced for the subsequent processing into pieces of clothing or corsetry.

In FIG. 5a, a mould core 12′ of the device 10, modified in the assignment of the individual guides 18 to a feed mechanism 14 or 16, is shown in cross section. The mould core 12′ differs from the mould core 12 described in the context of FIGS. 1 and 2 in that in each case longitudinally running slits or trough-shaped grooves 36 are included in the area of the longitudinal edge of the mould core, into which the respective web material 20 and 32 can be folded during the production process of the web material through a corresponding spatula-like guide element, as is shown in FIG. 5a, with respect to the web material 20. It is apparent that with the application of the mould core and folding in of the material webs 20 and 32 into the longitudinally running slits or trough-shaped grooves 36, the folded in areas of the web material 20 and 32 are not sprayed with the pressure-sensitive adhesive and are also not overlaid with the prestressed elastic threads or strands.

After the web material produced for the remainder in the manner described according to the invention is slit open, there arises a web material with the surface pattern 38 shown in FIG. 5b, in which strip-shaped surface areas arise that run parallel in the production direction in each case, which are alternately area-elastic through the elastic threads or strands, or not, or are only elastic within the limits of the elasticity of the fibres of the textile-web material.

It is obvious that modifications and further developments of the present description of the method according to the invention are possible within the scope of the invention. Such modifications can, for example, consist of the feed mechanisms 14 and 16 being driven in opposite directions, being driven at different rotation speeds, or being arranged offset from their orthogonal location surrounding the mould core to a position oblique to the longitudinal middle axis of the mould core. Through this, corresponding modifications of the surface pattern of the elastic threads or strands are obtained. Instead of using two textile-material webs, the method can also be implemented in such a way that only the first material web 20 is a textile material, for example, a mat, while the second material web 32 is composed of a film web, which is either applied in the form of a film or else applied and sprayed on in a state capable of flowing through heating or addition of temporary solvents, and subsequently hardening into a film layer through cooling or drying of the solvent.

Furthermore, it can be appropriate and advantageous, if, before or during the application of the second web material 32 onto the first material web, which is supplied with the elastic threads or strands, a powder, flake, or fibre fill material or functional material is applied, which, for example, can increase wearing comfort through a padding effect, or also have the function of an absorbent cushion for fluids.

1-11. (canceled)

12. A method for continuous production of a flexible, air-permeable web material with two outer material layers, at least one of which is made from a textile material, between which layers a prestressed, elastic intermediate layer is inserted, where the web material is shortened through the release of tension in the intermediate layer, and can again be extended elastically through exertion of tensile stress, where initially, the front end of the first outer layer of the textile material is applied onto the end section of a longitudinally extended rod-like or pipe-like mould core, and simultaneously with the initiation of a feed motion on the mould core, it is folded around the mould core in a tubular closed form, and then during the feed motion on the mould core, a pressure-sensitive adhesive is applied on the free top surface of the first outer layer;
where upon the tubular first layer, in the course of the further feed motion on the mould core, is guided through a feed mechanism for a group of elastic threads or strands under selectable elastic prestressing, where the elastic threads or strands are guided in the feed mechanism on a ring-shaped support surrounding the longitudinally extended mould core in individual guides arranged offset from each other in the circumferential direction, and applied onto the first outer layer, and are bound with it by the pressure-sensitive adhesive, where the ring-shaped support of the individual guides during the feed motion of the tubular first layer on the mould core is driven rotationally about the longitudinal axis of the mould core, so that the threads or strands are applied on the tubular first layer, because of the overlaid feed motion of the first layer and the rotation of the supports running obliquely and oriented essentially parallel to each other and surrounding the tubular first layer in each case, in the form of a tubular reinforcement, and then the second material layer is applied onto the first tubular material layer, overlaid with the applied groups of elastic threads or strands, and during the further feed motion is folded tubularly around the mould core, and is bonded through adhesion to the first material layer and the applied elastic threads or strands, whereupon the so created tube-like web material is sliced open in the longitudinal direction and unfolded into an essentially plane-surface web material, characterised in that
through a further feed mechanism, downstream in the feed direction, driven in the opposite direction of rotation, in each case a further group of elastic threads or strands oriented essentially parallel to each other, running diagonally in the opposite direction to the first group, are applied to the applied group of elastic threads or strands onto the tubular layer and adhesively bonded with it, and
that the elastic threads or strands of both groups during the application onto and the adhesive bonding are bound with the tubular web material, where said threads or strands are lengthened, in contrast to their unstressed state, through a prestressing corresponding to the desired elastic elongation of the finished web material.

13. A method according to claim 12, characterised in that the pressure-sensitive adhesive is applied before and/or after the application of the elastic threads or strands onto the free top surface of the first material layer during its feed motion on the mould core.

14. A method according to claim 12, characterised in that a textile material is used as the second material layer.

15. A method according to claim 12, characterised in that a film is used as the second material layer.

16. A method according to claim 15, characterised in that a film of a film material permeable to gas or water vapor, but impermeable to fluids is used.

17. A method according to claim 12, characterised in that onto the first material layer, overlaid with the applied groups of elastic threads or strands, as a second material layer a layer of a plastic is applied in a free-flowing state, which subsequently transforms into a flexible film or mat-like state.

18. A method according to claim 17, characterised in that a thermoplastic plastic material transformed into a free-flowing state through heating is used as a plastic, which, after application onto the first material, which is overlaid with the applied groups of elastic threads or strands, is transformed into a film-like or mat-like state through cooling.

19. A method according to claim 17, characterised in that a plastic material capable of hardening through evaporation or vaporisation of a solvent, or a plastic material, of a mixture of at least two fluid components, capable of hardening through cross-linking is used as a plastic.

20. A method according to claim 12, characterised in that a mould core, provided with at least two slit-shaped or trough-shaped grooves running in the longitudinal direction, offset from each other in the circumferential direction, is used, and that during application of the first material layer onto the mould core over the slit-shaped or trough-shaped grooves strip-like areas of the material layer are then moulded into the grooves and are held in the grooves during the feed motion.

21. A method according claim 12, characterised in that before or during the application of the second material layer onto the first material layer, which is provided with the groups of elastic threads or strands, a powder, flake, or fibre fill material or functional material is applied.
